(19) United States
(12) Patent Application Publication
(10) Pub. No.: US 2024/0079711 A1
(43) Pub. Date: Mar. 7, 2024

(54) STRUCTURAL DIVIDER FINS FOR USE WITHIN TRACTION BATTERY PACKS

(71) Applicant: FORD GLOBAL TECHNOLOGIES, LLC, Dearborn, MI (US)

(72) Inventors: Patrick Daniel Maguire, Ann Arbor, MI (US); Brock Dunlap, Dearborn, MI (US); Deanna Marie Winton Hoffman, Ann Arbor, MI (US); Michael E. Reibling, Sterling Heights, MI (US)

(21) Appl. No.: 18/105,399

(22) Filed: Feb. 3, 2023

Related U.S. Application Data
(60) Provisional application No. 63/403,445, filed on Sep. 2, 2022.

(51) Int. Cl. H01M 50/291; H01M 10/6554; H01M 10/658; H01M 50/211; H01M 50/262; H01M 50/271; H01M 50/293

(52) U.S. Cl. CPC H01M 50/291; H01M 10/6554; H01M 10/658; H01M 50/211; H01M 50/262; H01M 50/271; H01M 50/293; H01M 2220/20

(57) ABSTRACT

Divider fins are disclosed for traction battery packs. An exemplary divider fin may be arranged between adjacent battery cells of a battery cell stack. The divider fin may include an upper fin portion configured to interface with an enclosure cover, and a lower fin portion configured to interface with an enclosure tray or a heat exchange plate. The divider fin may be configured to compartmentalize the cell stack, structurally join upper and lower battery structures, contain thermal energy during battery thermal events, etc.

### CROSS-REFERENCE TO RELATED APPLICATIONS

This disclosure claims priority to U.S. Provisional Application No. 63/403,445, which was filed on Sep. 2, 2022 and is incorporated herein by reference.

### TECHNICAL FIELD

This disclosure relates generally to traction battery packs, and more particularly to divider fins for structurally coupling traction battery pack structures.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly including an enclosure tray and an enclosure cover, a cell stack housed within the enclosure assembly and including a plurality of battery cells, and a divider fin arranged between a first battery cell and a second battery cell of the plurality of battery cells. The divider fin includes an upper fin portion configured to interface with the enclosure cover or a first intermediate structure and a lower fin portion configured to interface with the enclosure tray or a second intermediate structure.

In a further non-limiting embodiment of the foregoing traction battery pack, the plurality of battery cells are stacked between a first cross-member beam and a second cross-member beam.

In a further non-limiting embodiment of either of the foregoing traction battery packs, the divider fin includes a protrusion that is sized to be accommodated within a C-channel of the first cross-member beam or the second cross-member beam.

In a further non-limiting embodiment of any of the foregoing traction battery packs, a mid-fin portion extends between the upper fin portion and the lower fin portion. The mid-fin portion is positioned between the first battery cell and the second battery cell.

In a further non-limiting embodiment of any of the foregoing traction battery packs, the upper fin portion, the lower fin portion, and the mid-fin portion establish a single-piece, unitary structure.

In a further non-limiting embodiment of any of the foregoing traction battery packs, at least one of the upper fin portion or the lower fin portion extends at a transverse angle relative to the mid-fin portion.

In a further non-limiting embodiment of any of the foregoing traction battery packs, the divider fin includes an S-shaped cross-section, a C-shaped cross-section, or an I-shaped cross-section.

In a further non-limiting embodiment of any of the foregoing traction battery packs, the divider fin includes an L-shaped cross-section or a T-shaped cross-section.

In a further non-limiting embodiment of any of the foregoing traction battery packs, the upper fin portion is configured to interface with the enclosure cover or the first intermediate structure by a first fastener, and the lower fin portion is configured to interface with the enclosure tray or the second intermediate structure by a second fastener.

In a further non-limiting embodiment of any of the foregoing traction battery packs, the first fastener and the second fastener each include an adhesive or a weld bead.

In a further non-limiting embodiment of any of the foregoing traction battery packs, the first fastener includes an adhesive or a weld bead, and the second fastener includes a thermal interface material disposed between the lower fin portion and the second intermediate structure.

In a further non-limiting embodiment of any of the foregoing traction battery packs, the divider fin includes an outer housing and an inner layer at least partially within the outer housing.

In a further non-limiting embodiment of any of the foregoing traction battery packs, the inner layer includes an insulating material, a compliant material, a heat absorption material, or combinations thereof.

In a further non-limiting embodiment of any of the foregoing traction battery packs, the divider fin includes a plastic panel and a thermal barrier assembly connected to the plastic panel. The thermal barrier assembly includes an outer housing and a thermal insulating barrier encapsulated within the outer housing.

In a further non-limiting embodiment of any of the foregoing traction battery packs, the first intermediate structure and the second intermediate structure are heat exchanger plates.

A traction battery pack according to another exemplary aspect of the present disclosure includes, among other things, a battery cell stack and a divider fin arranged to partition the battery cell stack into at least a first compartment and a second compartment. The divider fin structurally couples an upper enclosure structure to a lower enclosure structure of the traction battery pack.

In a further non-limiting embodiment of the foregoing traction battery pack, the divider fin includes an upper fin portion secured to the upper enclosure structure by a first fastener, and a lower fin portion secured to the lower enclosure structure by a second fastener.

In a further non-limiting embodiment of either of the foregoing traction battery packs, the first fastener and the second fastener each include an adhesive or a weld bead.

In a further non-limiting embodiment of any of the foregoing traction battery packs, the first fastener includes an adhesive or a weld bead, and the second fastener includes a thermal interface material disposed between the lower fin portion and the lower enclosure structure.

In a further non-limiting embodiment of any of the foregoing traction battery packs, the divider fin includes an outer housing and an inner layer at least partially within the outer housing. The inner layer includes an insulating material, a compliant material, a heat absorption material, or combinations thereof.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view through section 3-3 of FIG. 2.

FIG. 4 illustrates an exemplary divider fin of a traction battery pack.

FIG. 5 illustrates another exemplary divider fin.

FIG. 6 illustrates another exemplary divider fin.

FIG. 7 illustrates another exemplary divider fin.

FIG. 8 illustrates another exemplary divider fin.

FIG. 9 illustrates an interface between a divider fin of a cell stack and a heat exchanger plate.

FIG. 10 illustrates another exemplary divider fin.

FIG. 11 illustrates yet another exemplary divider fin.

FIG. 12 illustrates an interface between a divider fin and a cross-member beam of a cell stack of a traction battery pack.

FIG. 13 illustrates an interface between a divider fin and an upper and lower structure of a traction battery pack.

### DETAILED DESCRIPTION

This disclosure details divider fins for traction battery packs. An exemplary divider fin may be arranged between adjacent battery cells of a battery cell stack. The divider fin may include an upper fin portion configured to interface with an enclosure cover, and a lower fin portion configured to interface with an enclosure tray or a heat exchange plate. The divider fin may be configured to compartmentalize the cell stack, structurally join upper and lower battery structures, contain thermal energy during battery thermal events, etc. These and other features are discussed in greater detail in the following paragraphs of this detailed description.

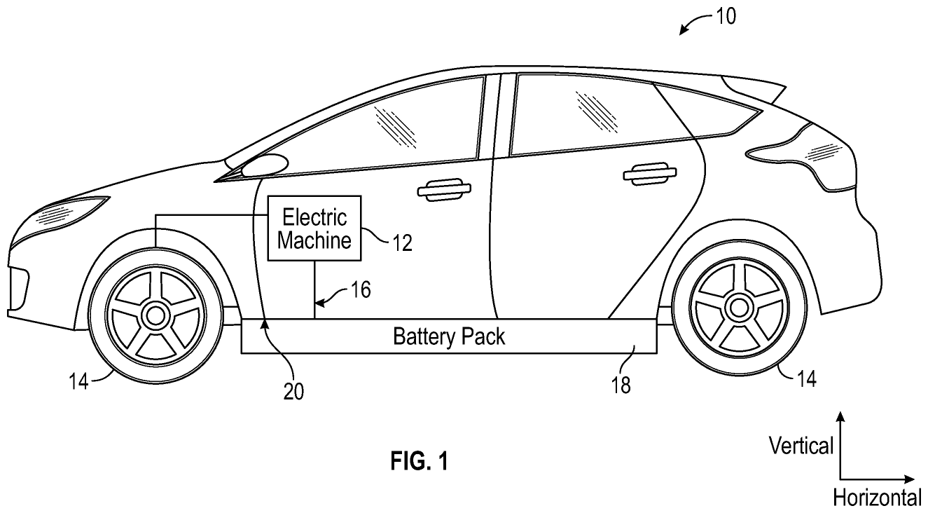

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

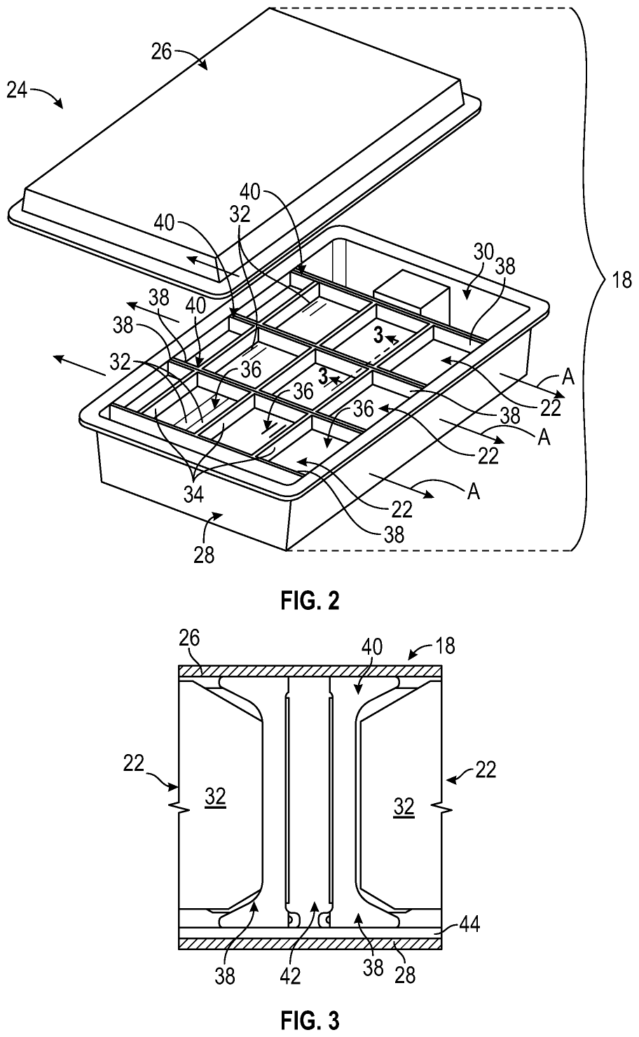

FIGS. 2 and 3 illustrate additional details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cells stacks 22 and other battery internal components.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals extending from a battery cell housing. An aluminum film may provide the battery cell housing, for example.

The battery cells 32 of each cell stack 22 may be arranged between a pair of cross-member beams 38. The cross-member beams 38 may be configured to hold the battery cells 32 and at least partially delineate the cell stacks 22.

Immediately adjacent-cross member beams 38 may establish a cross-member assembly 40 disposed between adjacent cell stacks 22 of the traction battery pack 18. The cross-member assemblies 40 may be configured to transfer a load applied to a side of the electrified vehicle 10, for example. Each cross-member beam 38 of the cross-member assemblies 40 may be a structural beam that can help accommodate tension loads from battery cell 32 expansion and compression loads. The cross-member assemblies 40 are therefore configured to increase the structural integrity of the traction battery pack 18.

The cross-member assemblies 40 may also establish a battery pack venting system for communicating battery cell vent byproducts from the traction battery pack 18 during battery thermal events. For example, the cross-member assemblies 40 may establish passageways 42 (best shown in FIG. 3) that can communicate battery cell vent byproducts from the cell stacks 22 toward a position where the battery cell vent byproducts can be expelled from the traction battery pack 18.

In the exemplary embodiment, first and second adjacent cross-member beams 38 may establish a first side and a second side, respectively, of the passageway 42 of the cross-member assembly 40. Further, a vertically upper side of the passageway 42 may be established by the enclosure cover 26 (see FIG. 3), and a vertically lower side of the passageway 42 may be established by a heat exchanger plate 44 positioned against the enclosure tray 28 (see FIG. 3). In another embodiment, the heat exchanger plate 44 may be omitted and the vertically lower side of the passageway 42 may be established by the enclosure tray 28. In yet another embodiment, the heat exchanger plate 44 may be above the cross-member assembly 40 and the enclosure tray 28 beneath the cross-member assembly 40. Vertical and horizontal, for purposes of this disclosure, are with reference to ground and a general orientation of traction battery pack 18 when installed within the electrified vehicle 10 of FIG. 1.

Each cross-member beam 38 may include one or more openings (not shown) for communicating the battery cell vent byproducts through the beams and into the passageway 42. These openings may be normally closed, but may be configured to open in response to a condition (such as vent gas pressure) when a battery cell is venting. The openings may thus provide a path for battery cell vent byproducts to move to the passageways 42 as required. Each cross-member beam 38 may additionally include one or more openings (not shown) for accommodating cell tabs of the battery cells 32.

The cross-member beams 38 may be adhesively secured to the enclosure cover 26 and to the heat exchanger plate 44 and/or enclosure tray 28. The adhesive can seal these interfaces to inhibit battery cell vent byproducts escaping the passageway 42 through these areas.

In an embodiment, the cells stacks 22, the cross-member assemblies 40, and the respective passageways 42 extend longitudinally in a cross-vehicle direction. However, other configurations and orientations are further contemplated within the scope of this disclosure.

One or more divider fins 34 may be arranged along the respective cell stack axis A of each cell stack 22. The divider fins 34 may divide or compartmentalize each cell stack 22 into two or more groupings or compartments 36 of battery cells 32. Should, for example, a battery thermal event occur in one of the cell stacks 22, the divider fins 34 may reduce or even prevent thermal energy associated with the thermal event from moving from cell-to-cell, compartment-to-compartment, and/or cell stack-to-cell stack, thereby inhibiting thermal propagation inside the traction battery pack 18. As further explained below, the divider fins 34 may also structurally join battery structures to increase the structural integrity of the traction battery pack 18.

Each compartment 36 may hold one or more of the battery cells 32 of one of the cell stacks 22. In an embodiment, the battery cells 32 of each cell stack 22 are held within one of four compartments 36. However, other configurations, including configurations that utilize a greater or fewer number of divider fins 34 and compartments 36, could be used within the scope of this disclosure.

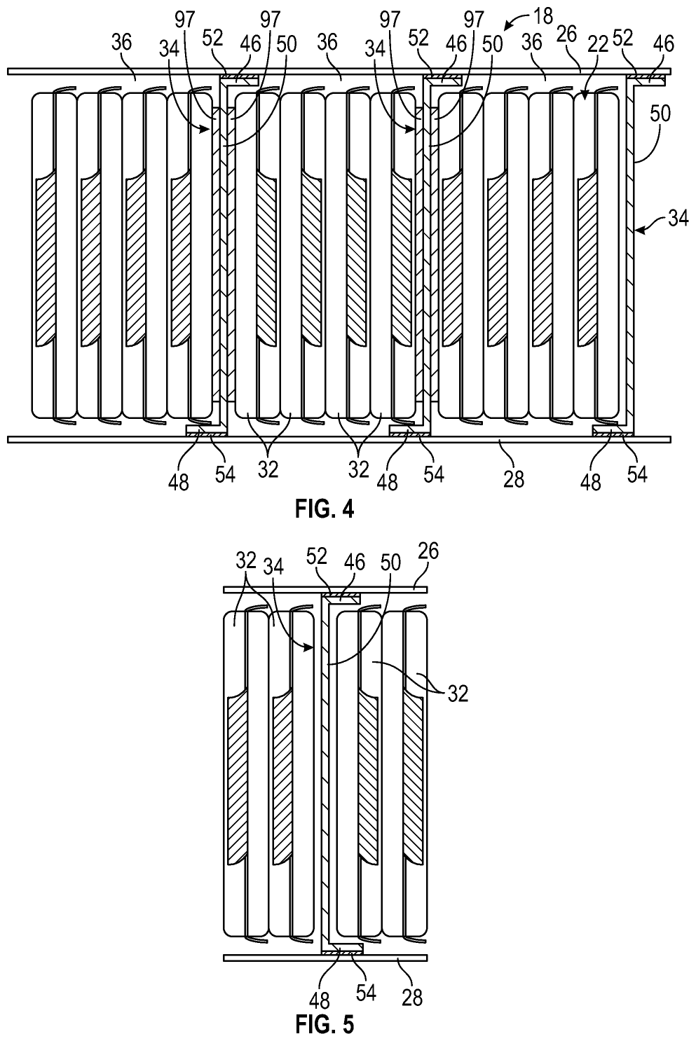

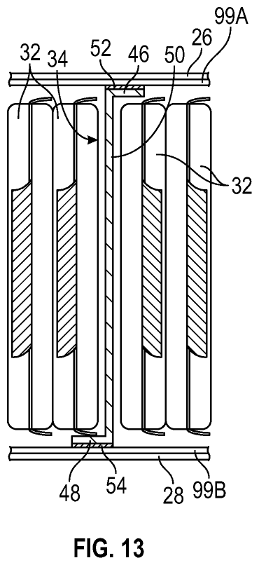

Referring to FIG. 4, each divider fin 34 may include an upper fin portion 46, a lower fin portion 48, and a mid-fin portion 50 extending between the upper fin portion 46 and the lower fin portion 48. The upper fin portion 46 may be configured to interface with the enclosure cover 26, and the lower fin portion 48 may be configured to interface with the enclosure tray 28. In some implementations, the upper fin portion 46 may interface with the enclosure cover 26 through an intermediate structure 99A that is secured to the enclosure cover 26, and the lower fin portion 48 may interface with the enclosure tray 28 through an intermediate structure 99B that is secured to the enclosure tray 28 (see FIG. 13). The intermediate structures 99A, 99B may be heat exchanger plates, for example. The mid-fin portion 50 may be positioned axially between adjacent battery cells 32 of the cell stack 22.

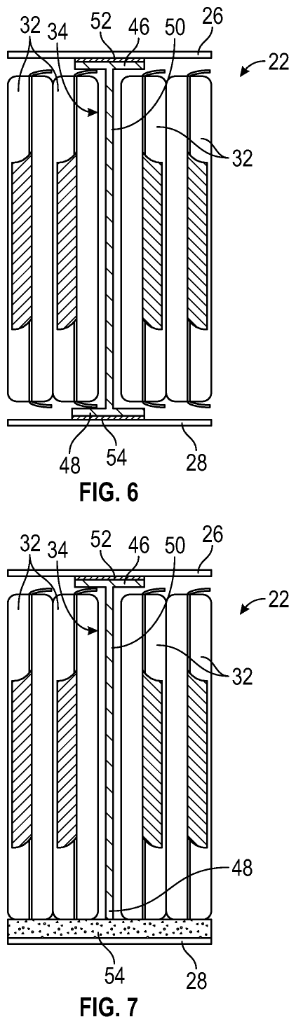

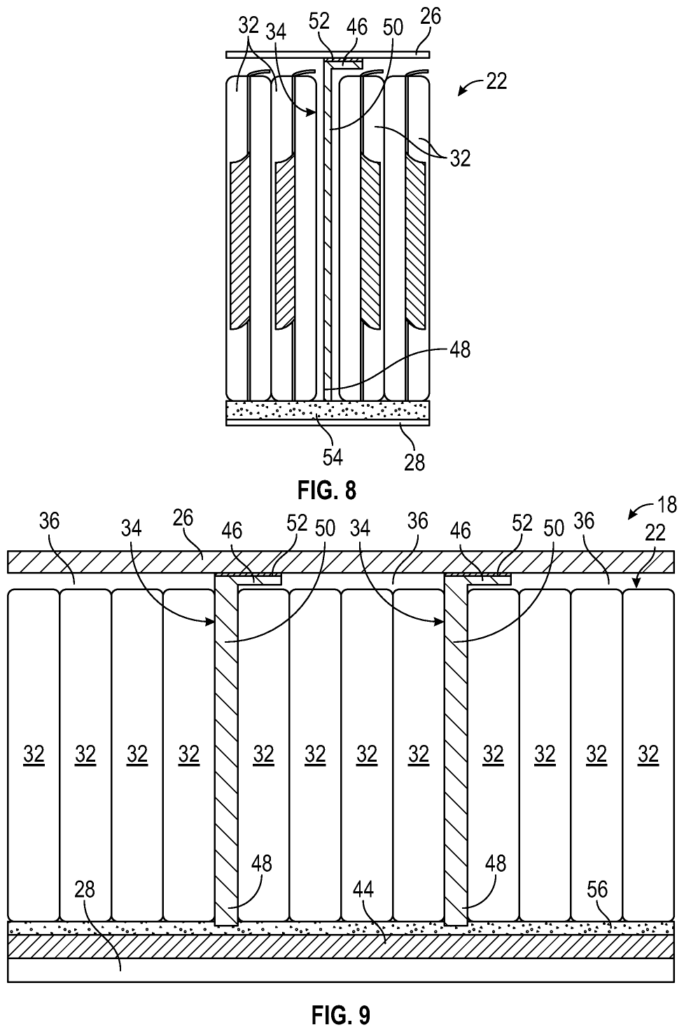

In an embodiment, each divider fin 34 includes a general S-shaped cross-section (see, e.g., FIG. 4). However, other cross-sectional shapes, such as a C-shaped cross-section (see FIG. 5), an I-shaped cross-section (see FIG. 6), a T-shaped cross-section (see FIG. 7), an L-shaped cross-section (see FIG. 8), etc., are also possible within the scope of this disclosure.

In another embodiment, the divider fan 34 can be sandwiched between foam pads 97. The foam pads 97 may be configured to accommodate battery cell expansion forces due to swelling, for example.

The upper fin portion 46 may be configured as a flange that extends at a transverse angle (e.g., about perpendicular) from the mid-fin portion 50. The upper fin portion 46 may be fixedly secured to the enclosure cover 26 to increase the rigidity/stiffness of the traction battery pack 18. A fastener 52 may be utilized to secure the upper fin portion 46 to the enclosure cover 26. In an embodiment, the fastener 52 is an adhesive, such as an epoxy based adhesive or a urethane based adhesive, for example. In another embodiment, the fastener 52 is a weld bead. In yet another embodiment, the fastener 52 is an interference fit connection (e.g., bulb-and-groove connection). However, other types of fasteners may be utilized to join the upper fin portion 46 to the enclosure cover 26.

In an embodiment, the lower fin portion 48 is configured as a flange that extends at a transverse angle (e.g., about perpendicular) from the mid-fin portion 50 at an opposite end of the mid-fin portion 50 from the upper fin portion 46. The lower fin portion 48 may be fixedly secured to the enclosure tray 28 to increase the overall rigidity of the traction battery pack 18. A fastener 54 may be utilized to secure the lower fin portion 48 to the enclosure tray 28. In such an embodiment, the fastener 54 may be an adhesive, a weld bead, or a thermal interface material, for example.

In another embodiment, shown in FIG. 9, the fastener 54 may be a thermal interface material 56 that acts as an interface between the lower fin portion 48 and the heat exchanger plate 44, which may be fixedly secured to the enclosure tray 28. The thermal interface material 56 may secure the lower fin portion 48 relative to the heat exchanger plate 44 for further increasing the overall rigidity of the traction battery pack 18. In such an embodiment, the lower fin portion 48 may be configured as a base of the mid-fin portion 50 and therefore extends in parallel with the mid-fin portion 50. The thermal interface material 56 (e.g., epoxy resin, silicone based materials, thermal greases, etc.) may additionally be disposed between the battery cells 32 of the cell stack 22 and the heat exchanger plate 44 for facilitating heat transfer therebetween.

Once the upper fin portion 46 is joined to the enclosure cover 26 and the lower fin portion 48 is joined to the enclosure tray 28 and/or the heat exchanger plate 44, the enclosure cover 26 and enclosure tray 28 are effectively structurally coupled to one another. The divider fins 34 are therefore configured for increasing the structural stiffness of the traction battery pack 18.

In an embodiment, each divider fin 34 is made of a metallic material, such as stainless steel or aluminum, for example. In another embodiment, each divider fin 34 is made of a plastic material, such as a sheet moulding compound (SMC) or a glass fiber reinforced polypropylene, for example. However, other materials are further contemplated within the scope of this disclosure.

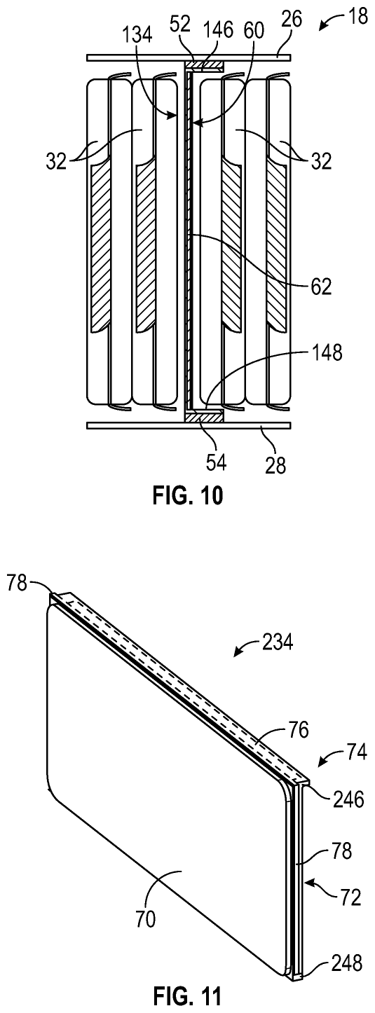

In the embodiments discussed above, the divider fins 34 include a single-piece, unitary structure. However, the divider fins could alternatively embody a multi-layer sandwich panel design. FIG. 10 illustrates an exemplary design of a multi-layered divider fin 134. The divider fin 134 may include an outer housing 60 and one or more inner layers 62 provided within the outer housing 60. The inner layer(s) 62 may be encapsulated inside the outer housing 60 and is therefore shielded by the outer housing 60.

The outer housing 60 may include an upper fin portion 146 and a lower fin portion 148. The upper fin portion 146 may interface with the enclosure cover 26, and the lower fin portion 148 may interface with the enclosure tray 28. A fastener 52 (e.g., a thermal adhesive or weld bead) may be utilized to secure the upper fin portion 146 to the enclosure cover 26, and a fastener 54 (e.g., a thermal adhesive, weld bead, or thermal interface material) may be utilized to secure the lower fin portion 148 to the enclosure tray 28. The divider fin 134 may therefore be configured for structurally coupling the enclosure cover 26 and the enclosure tray 28.

The outer housing 60 of the divider fin 134 may be made of a metallic material. In an embodiment, the outer housing 60 is made of stainless steel. In another embodiment, the outer housing 60 is made of aluminum. In another embodiment, each outer housing 60 is made of a plastic material, such as a sheet moulding compound (SMC) or a glass fiber reinforced polypropylene, for example. However, other materials are further contemplated within the scope of this disclosure. The outer housing 60 may include any of the shapes shown in FIGS. 4-8. The outer housing 60 may have structural features on the inside that partially or entirely pass through an area of the inner layer 62 to increase the stiffness of the divider fin 134 to the extent more stiffness is desired to resist cell swelling forces along the stack axis A.

The inner layer 62 may include an insulating material(s) for slowing or even preventing thermal propagation within the traction battery pack 18. The insulating material may include an aerogel material, such as a silica-based aerogel, or a foam material, such as a silicone foam, for example. However, other material or combinations of materials could with utilized to provide the inner layer 62 with insulative properties within the scope of this disclosure.

The inner layer 62 may alternatively or additionally include a compliant material(s) for accommodating battery cell swelling. The compliant material may include polyurethane foam, silicone foam, or aerogel materials, for example. However, other material or combinations of materials could with utilized to provide the inner layer 62 with compliant properties within the scope of this disclosure.

The inner layer 62 may alternatively or additionally include a heat absorption material(s) for absorbing heat during battery thermal events. The heat absorption material may include intumescent additives, such as expandable graphene or mono ammonium phosphate, for example. However, other material or combinations of materials could with utilized to provide the inner layer 62 with heat absorption properties within the scope of this disclosure.

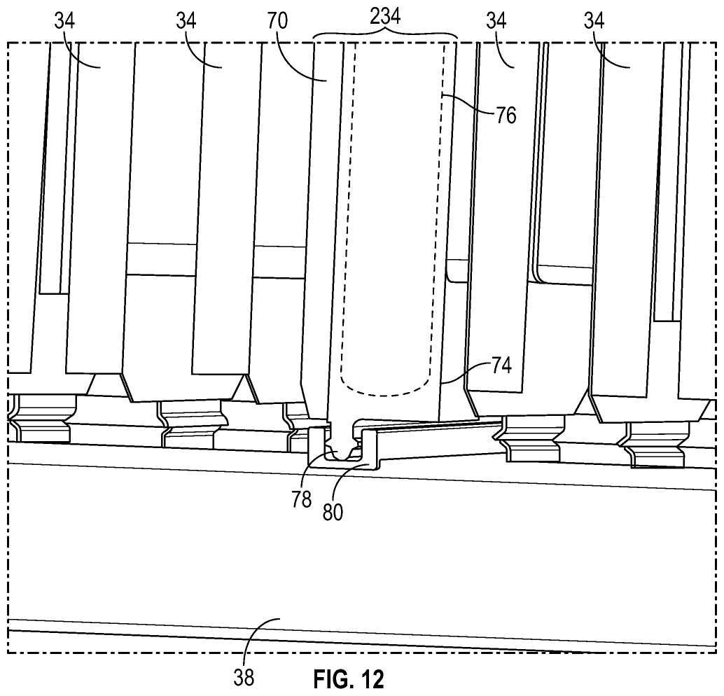

FIGS. 11-12 illustrate another divider fin 234 that includes a multi-layered design. The divider fin 234 may embody a two-piece design that includes a plastic panel 70 and a thermal barrier assembly 72 connected to the plastic panel 70. The thermal barrier assembly 72 may include an outer housing 74 and a thermal insulating barrier 76 encapsulated within the outer housing 74.

The plastic panel 70 may be made of a compliant material. Exemplary compliant materials include but are not limited to polyurethane foam and silicone foam. However, other materials are contemplated within the scope of this disclosure.

The outer housing 74 may include an upper fin portion 246 and a lower fin portion 248. The upper fin portion 246 may be configured to interface with the enclosure cover 26, and the lower fin portion 248 may be configured to interface with the enclosure tray 28 in any of the manners described above in order to structurally couple the enclosure cover 26 and the enclosure tray 28.

The outer housing 74 may be made of a polymeric material. In an embodiment, the outer housing 74 is made of polyethylene. However, other polymeric materials are contemplated within the scope of this disclosure. The outer housing 74 may be injection molded or spray transfer molded about the thermal insulating barrier 76.

The thermal insulating barrier 76 may possess a relatively high thermal resistance (and thus a low thermal conductivity) for slowing or even preventing thermal propagation within the traction battery pack 18. In an embodiment, the thermal insulating barrier 76 may include an aerogel material, such as a silica-based aerogel, for example. In another embodiment, the thermal insulating barrier 76 may include a foam material, such as a silicone foam, for example. However, other materials or combinations of materials could with utilized to construct the thermal insulating barrier 76 within the scope of this disclosure.

The outer housing 74 of the thermal barrier assembly 72 of the divider fin 234 may include features for interfacing with one of the cross-member beams 38 of the traction battery pack 18. For example, each opposing side of the outer housing 74 may include a protrusion 78 (e.g., a protruding barb) that is sized to be accommodated within a C-channel 80 of the cross-member beams 38. Together, the protrusion 78 and the C-channel 80 may establish a tongue-and-groove connection between the divider fin 234 and the cross-member beam 38. However, other types of connections (e.g., adhesive, etc.) could be used for connecting the thermal barrier assembly 72 to the cross-member beam 38.

The exemplary traction battery packs of this disclosure include divider fins arranged between adjacent battery cells of a cell stack. The divider fins may provide numerous advantages over known solutions, including but not limited to presenting a novel configuration for compartmentalizing the cell stack, structurally joining upper and lower battery structures, containing thermal energy during battery thermal events, etc.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly including an enclosure tray and an enclosure cover;
a cell stack housed within the enclosure assembly and including a plurality of battery cells; and
a divider fin arranged between a first battery cell and a second battery cell of the plurality of battery cells,
wherein the divider fin includes an upper fin portion configured to interface with the enclosure cover or a first intermediate structure and a lower fin portion configured to interface with the enclosure tray or a second intermediate structure.

2. The traction battery pack as recited in claim 1, wherein the plurality of battery cells are stacked between a first cross-member beam and a second cross-member beam.

3. The traction battery pack as recited in claim 2, wherein the divider fin includes a protrusion that is sized to be accommodated within a C-channel of the first cross-member beam or the second cross-member beam.

4. The traction battery pack as recited in claim 1, comprising a mid-fin portion extending between the upper fin portion and the lower fin portion, wherein the mid-fin portion is positioned between the first battery cell and the second battery cell.

5. The traction battery pack as recited in claim 4, wherein the upper fin portion, the lower fin portion, and the mid-fin portion establish a single-piece, unitary structure.

6. The traction battery pack as recited in claim 4, wherein at least one of the upper fin portion or the lower fin portion extends at a transverse angle relative to the mid-fin portion.

7. The traction battery pack as recited in claim 6, wherein the divider fin includes an S-shaped cross-section, a C-shaped cross-section, or an I-shaped cross-section.

8. The traction battery pack as recited in claim 6, wherein the divider fin includes an L-shaped cross-section or a T-shaped cross-section.

9. The traction battery pack as recited in claim 1, wherein the upper fin portion is configured to interface with the enclosure cover or the first intermediate structure by a first fastener, and the lower fin portion is configured to interface with the enclosure tray or the second intermediate structure by a second fastener.

10. The traction battery pack as recited in claim 9, wherein the first fastener and the second fastener each include an adhesive or a weld bead.

11. The traction battery pack as recited in claim 9, wherein the first fastener includes an adhesive or a weld bead, and the second fastener includes a thermal interface material disposed between the lower fin portion and the second intermediate structure.

12. The traction battery pack as recited in claim 1, wherein the divider fin includes an outer housing and an inner layer at least partially within the outer housing.

13. The traction battery pack as recited in claim 12, wherein the inner layer includes an insulating material, a compliant material, a heat absorption material, or combinations thereof.

14. The traction battery pack as recited in claim 1, wherein the divider fin includes a plastic panel and a thermal barrier assembly connected to the plastic panel, and further wherein the thermal barrier assembly includes an outer housing and a thermal insulating barrier encapsulated within the outer housing.

15. The traction battery pack as recited in claim 1, wherein the first intermediate structure and the second intermediate structure are heat exchanger plates.

16. A traction battery pack, comprising:
a battery cell stack; and
a divider fin arranged to partition the battery cell stack into at least a first compartment and a second compartment,
wherein the divider fin structurally couples an upper enclosure structure to a lower enclosure structure of the traction battery pack.

17. The traction battery pack as recited in claim 16, wherein the divider fin includes an upper fin portion secured to the upper enclosure structure by a first fastener, and a lower fin portion secured to the lower enclosure structure by a second fastener.

18. The traction battery pack as recited in claim 17, wherein the first fastener and the second fastener each include an adhesive or a weld bead.

19. The traction battery pack as recited in claim 17, wherein the first fastener includes an adhesive or a weld bead, and the second fastener includes a thermal interface material disposed between the lower fin portion and the lower enclosure structure.

20. The traction battery pack as recited in claim 16, wherein the divider fin includes an outer housing and an inner layer at least partially within the outer housing, and further wherein the inner layer includes an insulating material, a compliant material, a heat absorption material, or combinations thereof.
